(19) United States
(12) Patent Application Publication
(10) Pub. No.: US 2025/0340413 A1
(43) Pub. Date: Nov. 6, 2025

(54) Vehicle Ramp

(71) Applicant: Zhibao HE, Shandong (CN)

(72) Inventor: Zhibao HE, Shandong (CN)

(21) Appl. No.: 19/267,882

(22) Filed: Jul. 14, 2025

(51) Int. Cl. B66F 7/24

(52) U.S. Cl. CPC B66F 7/243

(57) ABSTRACT

The present disclosure relates to a vehicle ramp, comprising a ramp body formed by an acute-angle front ramp portion and a rear ramp portion. The core innovation lies in the pivotally connected rotatable anti-slip washer at the lip edge of the front ramp portion: when deployed, it forms a ground transition extension zone, where a reverse static friction force is generated between the washer and the ground utilizing the downforce of the tire, which effectively prevents rearward sliding displacement of the ramp. The washer achieves deployment and locking through the nesting of the protrusion and hollowed-out area, and when retracted, it is secured by a latching block within the groove to maintain the cleanliness of the friction surface.

### TECHNICAL FIELD

The present disclosure relates to the technical field of automotive auxiliary equipment, particularly to a vehicle ramp.

### BACKGROUND

Traditional vehicle ramps typically rely on surface patterns or the material's own coefficient of friction to provide anti-slip effects. However, this friction is often insufficient to secure the vehicle ramp on the ground, especially in environments like smooth-floored underground garages. When a vehicle tire drives onto the ramp, it exerts an impact force along the downward slope of the ramp. On the contact surface between the ramp and the smooth garage floor, this impact force generates a backward component parallel to the ground. When this backward component is significant, it can easily cause the ramp to slide or shift backward.

As shown in U.S. Patent US20220381036A1, increasing the friction by adding coarse sand material to the ramp surface is proposed. However, this patent has certain issues—its anti-slip mechanism focuses solely on improving friction at the interface between the ramp and the tire, failing to effectively address the anti-slip problem between the ramp's bottom and the smooth garage floor.

### SUMMARY

The present disclosure provides a vehicle ramp to solve the problems raised in the background art.

To achieve the above object of the present disclosure, the following technical solutions are adopted in the present disclosure:

A vehicle ramp comprises a ramp body; an anti-slip assembly, comprising: an anti-slip washer pivotally connected to a ground connecting edge at a front end of the ramp body through a pivot shaft. The anti-slip washer has: a retracted state: the anti-slip washer is fitted to a contour of a front edge of the ramp body; and a deployed state: the anti-slip washer is rotated to be deployed beyond the front edge of the ramp body and lay flat on the ground. When the anti-slip washer is in the deployed state and a vehicle tire drives onto the ramp body, part of the tire is located on an upper surface of the anti-slip washer, and a downforce of the tire generates a forward static friction force between the anti-slip washer and the ground, wherein the static friction force counteracts a rearward sliding force caused by an impact force of the tire and acting on a bottom part of the ramp body, thereby preventing the ramp body from sliding backward.

The present disclosure also adopts another technical solution: a vehicle ramp, comprising a ramp body; and an anti-slip assembly, comprising: an anti-slip washer translationally and slidably connected to a ground connecting edge at a front end of the ramp body. The anti-slip washer has: a retracted state: the anti-slip washer is fitted to a contour of a front edge of the ramp body; and a deployed state: the anti-slip washer slides to be deployed beyond the front edge of the ramp body and lay flat on the ground. When the anti-slip washer is in the deployed state and a vehicle tire drives onto the ramp body, part of the tire is located on an upper surface of the anti-slip washer, and a downforce of the tire generates a forward static friction force between the anti-slip washer and the ground, wherein the static friction force counteracts a rearward sliding force caused by an impact force of the tire and acting on a bottom part of the ramp body, thereby preventing the ramp body from sliding backward.

The present disclosure also adopts another technical solution: a vehicle ramp, comprising an anti-slip assembly, comprising: an anti-slip washer operably connected to a ground connecting edge at a front end of the ramp body. The anti-slip washer has: a retracted state: the anti-slip washer is fitted to a contour of a front edge of the ramp body; and a deployed state: the anti-slip washer is movably deployed beyond the front edge of the ramp body to lay flat on the ground. When the anti-slip washer is in the deployed state and a vehicle tire drives onto the ramp body, part of the tire is located on an upper surface of the anti-slip washer, and a downforce of the tire generates a forward static friction force between the anti-slip washer and the ground, wherein the static friction force counteracts a rearward sliding force caused by an impact force of the tire and acting on a bottom part of the ramp body, thereby preventing the ramp body from sliding backward.

The beneficial effects of the present disclosure compared to the prior art are as follows: When the anti-slip washer is deployed, it forms a transitional extension area between the front ramp portion and the ground, and is directly engaged with the ground by utilizing the high-friction material of the washer itself; when the vehicle tire comes into contact with the front ramp portion, the tire exerts a downward component force along the inclined surface of the ramp, generating a horizontally rearward sliding force at the bottom of the ramp. At this time, since the anti-slip washer is connected to the front ramp portion and part of the tire is positioned on the upper surface of the washer, a downward pressure can be applied to the anti-slip washer. The downforce from the tire creates a significant static friction force between the anti-slip washer and the ground, with the friction direction facing forward, thereby preventing the ramp from moving and avoiding any displacement of the ramp body.

### BRIEF DESCRIPTION OF DRAWINGS

The drawings, which form part of this application, are provided to further illustrate the present disclosure. The schematic embodiments and descriptions of the present disclosure are intended to explain the present disclosure and do not constitute any improper limitation thereof. In the drawings:

FIG. 1 is a perspective schematic view of an embodiment provided by the present disclosure;

FIG. 2 is a perspective schematic view of the bottom of the embodiment shown in FIG. 1;

FIG. 3 is another perspective schematic view of the embodiment shown in FIG. 2;

FIG. 4 is a partially enlarged schematic view of the embodiment shown in FIG. 2;

FIG. 5 is another schematic view of the embodiment shown in FIG. 4;

FIG. 6 is a perspective schematic view of the anti-slip washer when deployed in the embodiment shown in FIG. 1;

FIG. 7 is a perspective schematic view of the bottom of the embodiment shown in FIG. 6;

FIG. 8 is a partially enlarged schematic view of the embodiment shown in FIG. 7;

FIG. 9 is a structural schematic view of the anti-slip washer in the embodiment shown in FIG. 8;

FIG. 10 is a schematic diagram of force analysis in the embodiment shown in FIG. 1.

Reference signs: Ramp body (100); Front ramp portion (110); Groove (111); Protrusion (112); Latching block (113); Rear ramp portion (120); Protective flange (130); Anti-slip pattern (140); Reinforcement rib (150); Anti-slip washer (200); Hollowed-out area (210); Lip edge structure (A); Vehicle tire (B); Sliding force (F1); Pressure (F2); Static friction force (F3).

### DESCRIPTION OF EMBODIMENTS

The technical solution in the embodiment of the present disclosure will be clearly and completely described below with reference to the drawings. Obviously, the described embodiment is part of, rather than all of the embodiments of the present disclosure. The following description of at least one exemplary embodiment is illustrative in nature and is in no way intended to limit the present disclosure, its application or uses. Based on the embodiments in the present disclosure, all other embodiments obtained by those skilled in the art without creative work belong to the scope of protection of the present disclosure.

It should be noted that the terminology used here is only for describing specific embodiments, and is not intended to limit exemplary embodiments according to the present application. As used herein, the singular form is also intended to include the plural form unless the context clearly indicates otherwise. Furthermore, it should be appreciated that when the terms “comprising” and/or “including” are used in this specification, they specify the presence of features, steps, operations, devices, components and/or combinations thereof.

Unless otherwise specified, the relative arrangement of components and steps, numerical expressions and numerical values set forth in these embodiments do not limit the scope of the present disclosure. At the same time, it should be appreciated that for the convenience of description, the dimensions of various parts shown in the drawings are not drawn according to the actual scale relationship. Techniques, methods and equipment known to those skilled in the art may not be discussed in detail, but in appropriate cases, they should be regarded as part of the authorization specification. In all the examples shown and discussed herein, any specific values should be interpreted as illustrative, and not as limiting. Therefore, other examples of exemplary embodiments may have different values. It should be noted that similar numbers and letters indicate similar items in the following drawings, therefore once an item is defined in one drawing, it does not need to be further discussed in subsequent drawings.

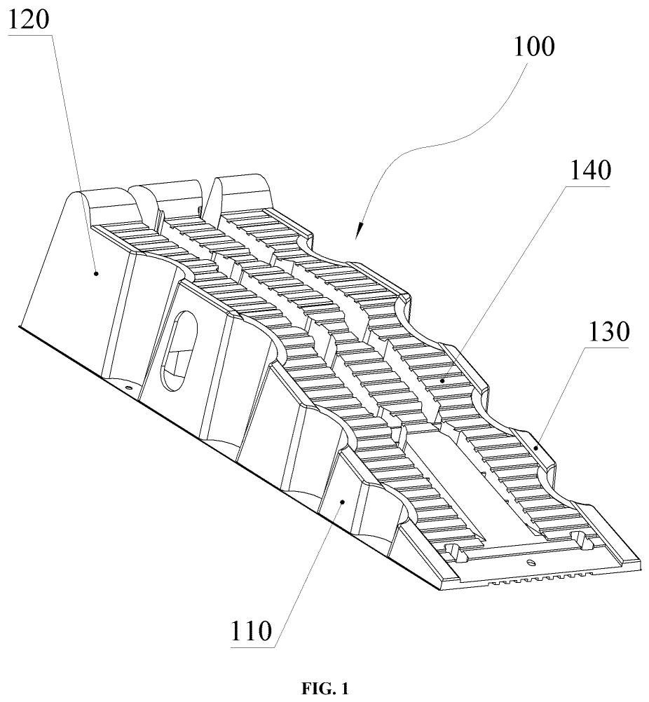

A vehicle ramp includes a ramp body 100 (refer to FIG. 1).

In other embodiments, as shown in FIG. 1, the ramp body 100 consists of a front ramp portion 110 and a rear ramp portion 120, where the front ramp portion 110 is an acute-angle ramp.

When a vehicle tire comes into contact with the front ramp portion 110, the acute-angle ramp disperses the vehicle pressure over a larger contact area, reducing localized pressure, distributing the vehicle load, and enhancing anti-slip effects.

In other embodiments (not shown), the ramp body 100 may adopt a modular segmented design, where the front ramp portion 110 and the rear ramp portion 120 are two independent units. The two are detachably connected at the joint surface through bolts or snaps, enabling flexible assembly. The joint area features an embedded connection structure. In a bolt connection solution, symmetrically distributed mounting holes are used, and matching lock nuts ensure stable fastening; in a snap-fit connection an elastic clasp mechanism is pre-installed on the joint surface, allowing quick engagement with a simple push. Both the connection modes incorporate anti-misalignment guide slots and visual alignment markers, supporting tool-free operation. For disassembly, it only needs to reverse the connection components for damage-free separation. This dual-mode connection system meets structural strength requirements for heavy-duty scenarios while offering convenience for temporary use. Independently packaged components form standardized transport units, significantly optimizing storage space utilization.

In other embodiments (not shown), the ramp body 100 may adopt a hinge folding system to achieve segmented folding functionality, where the front ramp portion 110 and the rear ramp portion 120 are two independent units. The junction between them is embedded with a high-load hinge assembly, whose rotating shaft employs a dual-bearing linkage structure, enabling the ramp segments to perform a 180-degree axial folding motion. Reinforced steel plates are installed on both sides of the hinge as lever supports, ensuring complete overlap of the front and rear segments during folding. The peripheral edge of the junction is equipped with cushioning rubber strips to prevent metal collisions. In the deployed state, the built-in limit latch of the hinge automatically pops out, locking the two segments into a straight configuration. To enhance the structural rigidity of the deployed form, two sets of locking pin systems are symmetrically arranged on both sides of the hinge shaft. The pin holes feature a tapered flared design, and the matching stainless steel pin rods have a guiding bevel at the front end, which automatically corrects positional deviations during insertion. The middle section of the pin rod integrates a spring self-locking mechanism. Once the pin fully penetrates the holes on both sides of the hinge, the end safety latch automatically springs up to form a physical stop, while the annular groove at the pin head creates an interference fit with the rubber ring inside the hole, ensuring anti-detachment in vibrating environments. Removal requires simultaneously pressing the release button at the tail of the pin rod to extract it, forming a dual safety mechanism. The entire hinge system is surface-treated with anti-rust coating, and all moving parts are equipped with oil injection ports for maintenance access.

In other embodiments (not shown), the ramp body 100 may be equipped with an integrated intelligent pressure monitoring system, featuring a high-sensitivity pressure sensor array embedded within the surface of the ramp body 100. The sensor modules adopt a honeycomb distribution design, with pressure-sensitive units encapsulated in stainless steel substrates and covered with a 5 mm-thick impact-resistant rubber layer, flush with the ramp surface. Each sensing unit incorporates a piezoresistive sensor chip, connected to a central control module through independent circuits, enabling real-time generation of 2D pressure heat maps of tire contact areas. When a vehicle enters, the system automatically activates dynamic baseline calibration, determining whether the vehicle's center of gravity is offset or the ramp's force distribution is imbalanced by comparing pressure differences between front and rear sensors. If the pressure on one side drops abruptly by more than 20% or the pressure gradient between adjacent sensor groups exceeds a set threshold, the control module triggers a multi-level alert protocol: first, RGB LED strips along the peripheral edge of the ramp flash red to highlight abnormal zones; if no correction is performed within 5 seconds, a high-decibel waterproof buzzer activates while simultaneously transmitting an alarm code to a remote terminal through wireless signal. The alarm module employs a redundant circuit design, with dual-channel sound units symmetrically arranged on both sides of the ramp, incorporating amplitude compensation algorithms to ensure acoustic coverage in noisy environments. LED warning lights are integrated into the anti-slip strips of the ramp, and 360-degree visible warning is realized by using diffuse light-guiding technology. The system includes a manual mute button and self-diagnostic functions, while the sensor modules feature plug-and-play encapsulation for tool-free replacement of damaged units.

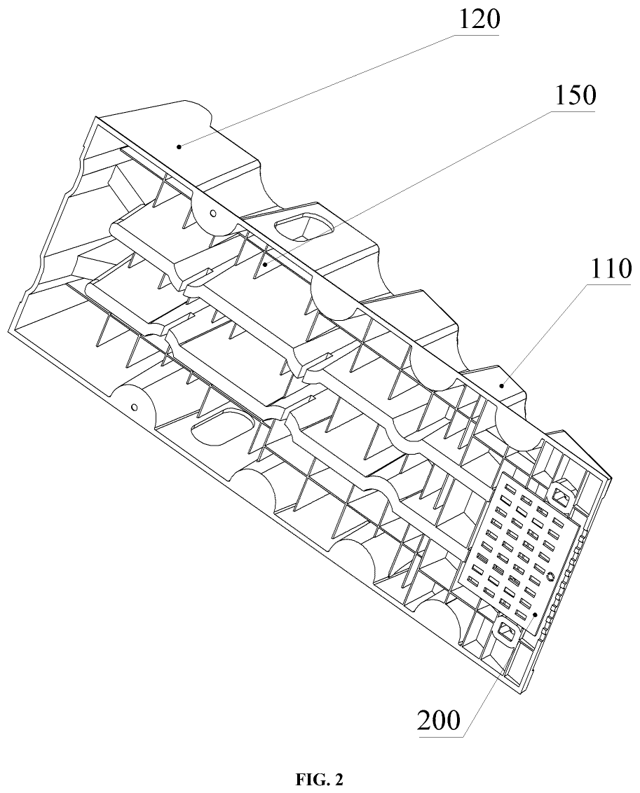

In this embodiment, as shown in FIG. 1, the ramp body 100 is flanked by protective flanges 130 on both sides, while its upper surface is textured with anti-slip patterns 140. As illustrated in FIG. 2, reinforcement ribs 150 are embedded within the ramp body 100.

The ramp body 100, with protective flanges 130 installed on both sides, prevents vehicles from sliding off during accidental deviations, particularly on slopes where lateral skidding is common, by providing physical barriers. Its surface anti-slip pattern ensures multidirectional traction in wet, icy, or snowy conditions, while internal reinforcement ribs significantly enhance structural rigidity and distribute load pressure. These three elements work synergistically to ensure transit safety while delivering all-weather adaptability and long-term deformation-resistant durability.

In other embodiments (not shown), the inner surface of the vertical segment of the protective flange 130 and the side contour of the ramp body 100 form a continuously extending guiding curved surface; the direction of the anti-slip pattern 140 forms a non-orthogonal angle with the inclination direction of the acute-angle ramp structure; the reinforcement ribs 150 are radially distributed within the ramp body 100, with their radial distribution center coinciding with the vertex of the acute-angle ramp structure, and the ends of the reinforcement ribs 150 extend to the root of the protective flange 130 to form an integrated support structure.

In other embodiments (not shown), the reinforcement ribs 150 include a grid layout formed by longitudinal main ribs and transverse cross ribs.

In other embodiments (not shown), the anti-slip pattern 140 may be a diamond grid pattern. The three-dimensional recessed structure of the diamond grid can simultaneously utilize the “edge effect” of the pattern's peripheral edges and the “interlocking effect” of the grooves to create a three-dimensional barrier for contact surfaces such as tires and shoe soles, especially in fluid-lubricated interfaces caused by rain or snow, breaking through the surface water film to achieve physical adhesion. To address the issue of debris accumulation like rainwater or dust on the ramp, the topological connectivity of the diamond grid allows debris to slide away directionally along the grid channels (rather than accumulating in closed grooves), reducing the risk of anti-slip performance degradation caused by debris coverage.

In other embodiments (not shown), the reinforcement ribs 150 are I-shaped metal skeletons. The I-shaped cross-section forms biaxial compression/tension zones through the wide-flange design of the upper and lower flanges, combined with the efficient force-transfer path of the vertical web, significantly enhancing the ramp's resistance to bending under concentrated vehicle loads and preventing localized collapse. Meanwhile, the elastic modulus gradient of the metal skeleton can absorb impact vibration energy, reducing fatigue crack propagation caused by frequent rolling, making it particularly suitable for high-impact scenarios such as forklifts and trucks.

In other embodiments (not shown), V-shaped drainage grooves are intermittently opened along the anti-slip pattern 140, with anti-slip particles covering the grooves. Meanwhile, the ramp body 100 is equipped with diversion pipes at its bottom that connect to the V-shaped drainage grooves, directing accumulated water to both sides of the ramp body. The V-shaped drainage grooves utilize their sharp-angle cross-sections to efficiently collect surface water flow, prioritizing the prevention of water layer formation. Simultaneously, the anti-slip particles within the grooves penetrate residual water films under wet conditions to maintain basic friction. The bottom diversion pipes rely on gravity to channel water directionally to the sides of the ramp, avoiding water seepage that could cause corrosion of the ramp skeleton and eliminating the drainage lag associated with traditional ramps relying on natural evaporation. Additionally, the inclined walls of the V-shaped grooves disperse localized impact forces during vehicle compression, and combined with the embedded layout of the anti-slip particles, they create a dual-state (dry/wet) anti-slip redundancy, ensuring slip-resistant stability even in extreme weather and preventing a decline in the friction coefficient of the ramp body 100's upper surface due to rainwater accumulation.

In other embodiments (not shown), removable anti-slip plates are installed on the upper surface of the ramp body 100, working in conjunction with the anti-slip pattern 140 to form a multi-layered anti-slip structure. The composite overlay of the anti-slip plates and the anti-slip pattern 140 creates a dynamic anti-slip system: the base pattern provides all-weather friction, while the anti-slip plates can be quickly replaced with specialized anti-slip layers such as spikes or rubber particles to enhance traction as needed for varying conditions like rain, snow, or oil contamination. Moreover, the anti-slip plates are installed through snap-fit or bolt mechanisms, allowing worn plates to be replaced individually, significantly extending the service life of the ramp body and reducing maintenance costs.

In other embodiments (not shown), the interior of the anti-slip pattern 140 is provided with a cavity filled with a repair agent. When cracks appear in the anti-slip pattern 140 due to long-term wear, the repair agent inside the cavity is discharged through the cracks, directionally infiltrates the defective area through capillary action, and undergoes an oxidative cross-linking reaction upon contact with air, forming an elastic filling layer compatible with the base material. This achieves self-sealing repair of the cracks while regenerating a microscopically rough structure on the repair surface, restoring anti-slip performance and extending the service life of the anti-slip pattern 140. Additionally, the repair agent can be a microencapsulated two-component epoxy resin, which forms a high-strength repair body after curing.

In other embodiments (not shown), the anti-slip pattern 140 is made of carbon fiber-reinforced polymer or ceramic coating, enhancing its wear resistance.

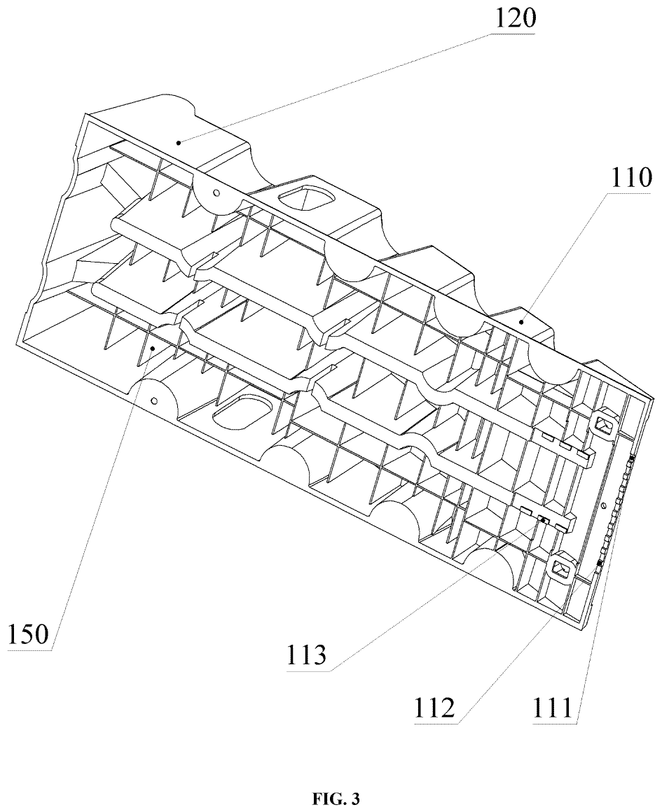

In this embodiment, as shown in FIGS. 3, 4, 5, and 8, the front ramp portion 110 is provided with a groove 111 at the end away from the rear ramp portion 120. The inner wall of the groove 111 is pivotally connected to an anti-slip washer 200 through a rotating shaft, and one end of the groove 111 is flush with the lip edge of the front ramp portion 110.

Here, the anti-slip washer 200 lies on the same plane as the inner wall of the front ramp portion 110 and can rotate clockwise or counterclockwise within this plane.

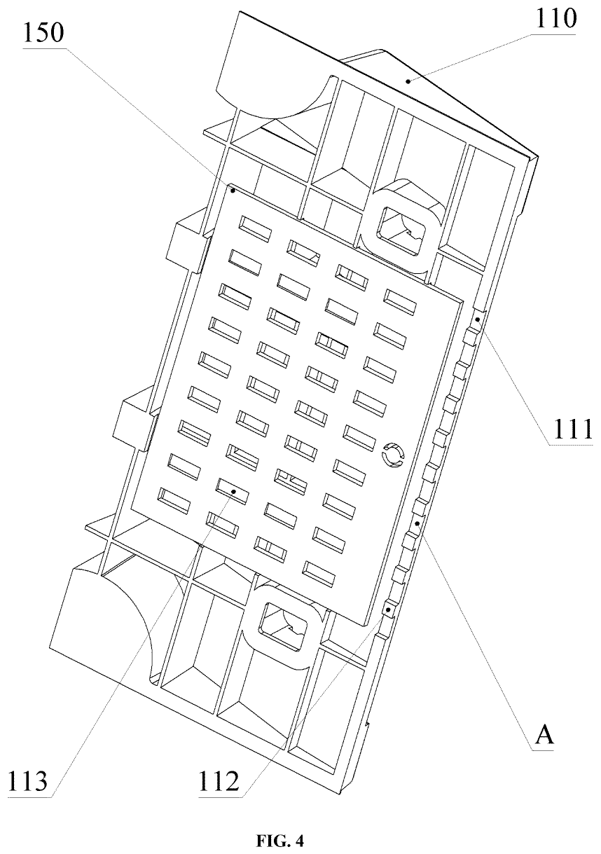

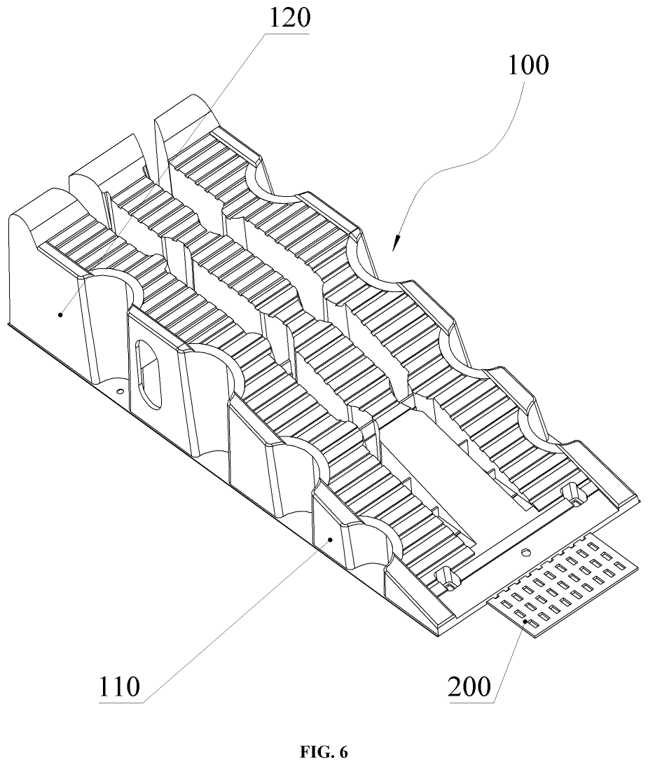

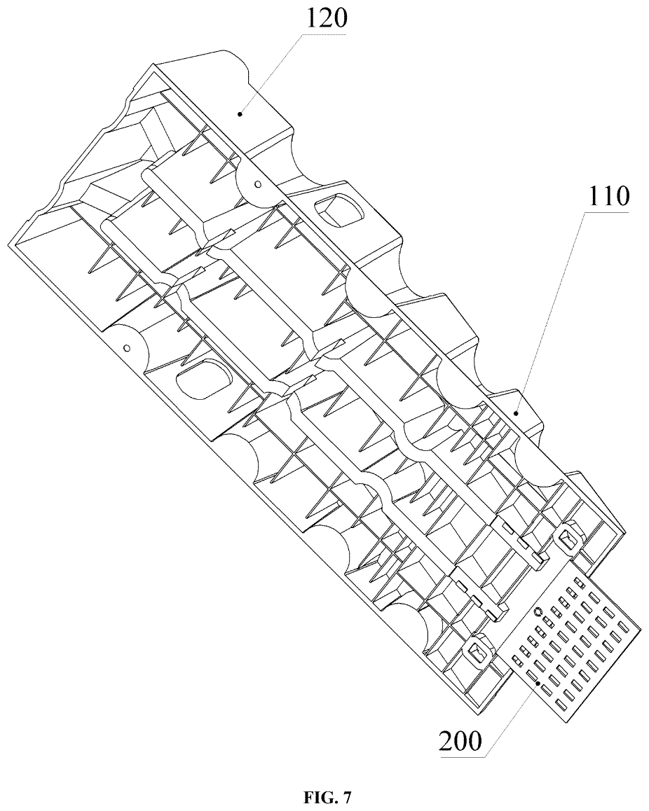

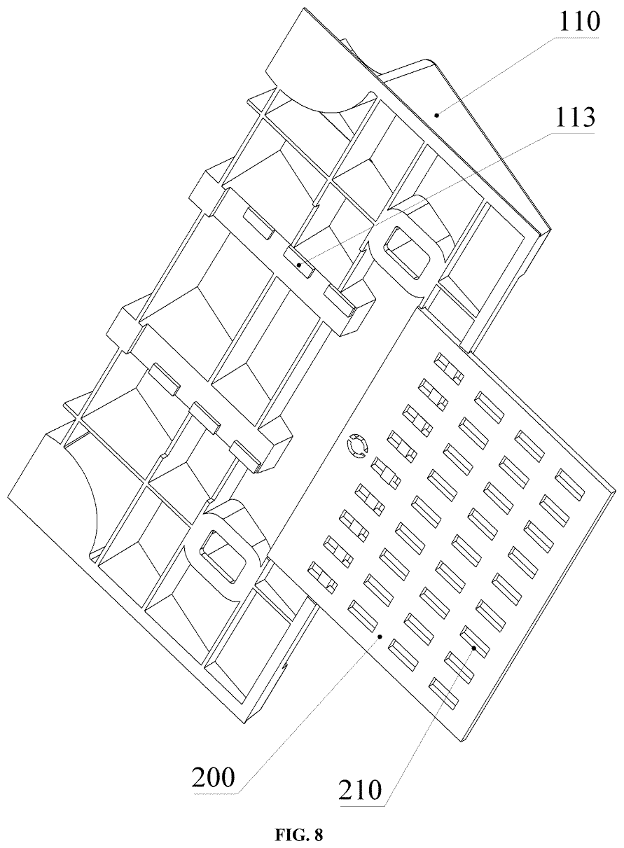

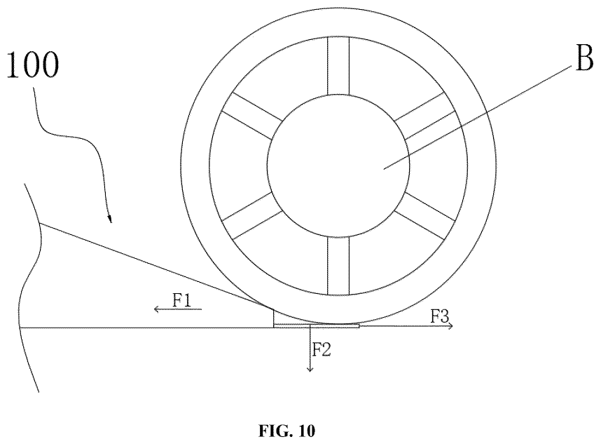

As shown in FIGS. 4 and 8, when the ramp body 100 is in use, the anti-slip washer 200 can be rotated out of the groove 111. As shown in FIGS. 6 and 7, after the anti-slip washer 200 is rotated and deployed, it forms a transitional extension area between the front ramp portion 110 and the ground, and is directly engaged with the ground by utilizing its high-friction material (e.g., rubber or textured metal). As shown in FIG. 10, when a vehicle tire contacts the front ramp portion 110, the tire applies a downward component force (impact force) along the ramp slope. This force generates a horizontally rearward sliding force at the bottom of the ramp. At this point, since the anti-slip washer 200 is connected to the front ramp portion 110 and part of the tire rests on its upper surface, the tire exerts downward pressure on the anti-slip washer 200. This downforce creates significant static friction between the anti-slip washer 200 and the ground, directed forward (opposing the ramp's tendency to slide backward), thereby preventing ramp movement and avoiding displacement of the ramp body 100.

Furthermore, when the anti-slip washer 200 is laid flat, it increases the ground contact area, dispersing the concentrated load of the ramp over a larger surface area to prevent the peripheral edge of the ramp from causing crushing damage to fragile surfaces (such as tiles or epoxy flooring).

In other embodiments (not shown), the pivot shaft is omitted, and instead, a plurality of snap fasteners are used to secure the anti-slip washer 200 to the bottom of the ramp body 100. When the anti-slip washer 200 needs to be deployed, workers simply remove the snap fasteners to release the restraint on the anti-slip washer 200, allowing it to unfold smoothly.

In other embodiments (not shown), both the top and bottom of the anti-slip washer 200 are equipped with replaceable friction layers.

In other embodiments (not shown), the bottom of the anti-slip washer 200 may feature a plurality of ground spikes. When the anti-slip washer 200 is rotated and deployed, the spikes wedge into soft/uneven surfaces (such as grass, gravel, snow, or ice) with their tips, creating mechanical anchor points through physical engagement. This overcomes the traditional reliance on surface hardness for friction-based anti-slip measures, preventing the entire washer from sliding on non-hardened surfaces. Additionally, the spikes distribute the washer's pressure across discrete contact points, avoiding localized collapse in soft surfaces (e.g., water film extrusion in muddy ground causing slippage) while maintaining surface contact friction between the washer and the ground, achieving a dual-mode anti-slip mechanism of “piercing+friction.”

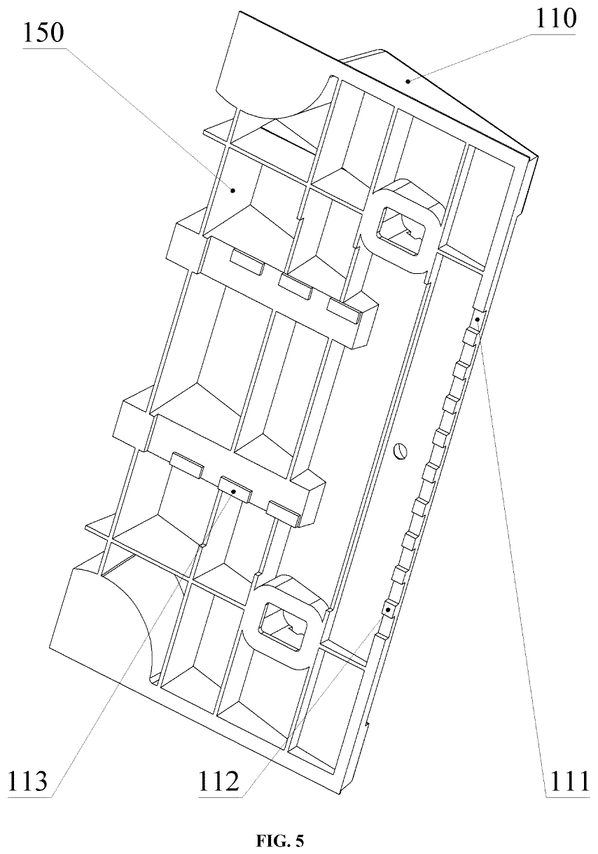

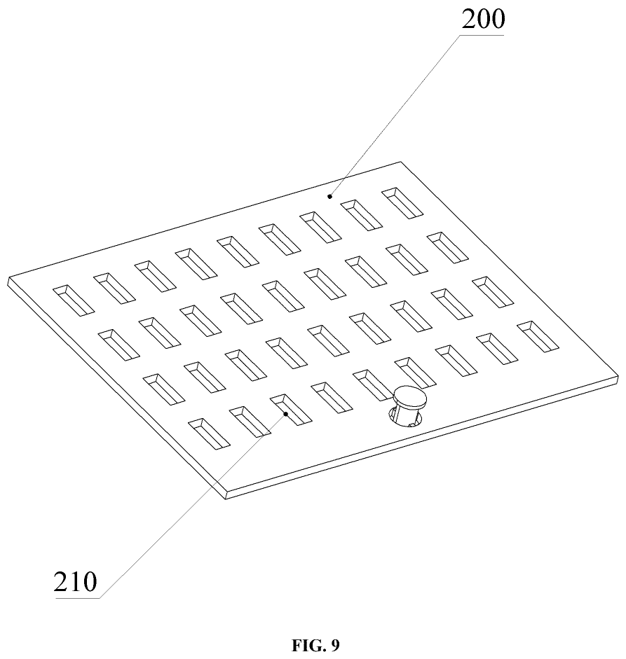

In other embodiments, as shown in FIG. 5, a plurality of protrusions 112 are arranged on the inner wall of the groove 111 near the lip edge of the front ramp portion 110. As shown in FIG. 9, the anti-slip washer 200 has a plurality of hollowed-out areas 210 on its surface, with the protrusions 112 and hollowed-out areas 210 being geometrically complementary. As illustrated in FIGS. 5 and 8, when the anti-slip washer 200 is deployed, the hollowed-out areas 210 are nested and fixed with the protrusions 112 on the inner wall of the groove 111. Here, the protrusions 112 restrict the washer's free movement through sidewall contact, eliminating micro-slippage caused by vehicle impact or uneven ground and ensuring the stability of the anti-slip washer 200.

In other embodiments (not shown), the protrusions 112 adopt a gradient hardness design (with wear-resistant rubber coating the exterior and a metal core inside), leveraging the rubber's elasticity to absorb instantaneous impacts while the metal core resists long-term plastic deformation.

In other embodiments (not shown), the peripheral edge of the hollowed-out area 210 is designed as a flared guide groove, allowing adaptive alignment within a certain angular deviation (without requiring precise alignment). Combined with the spherical transition at the top of the protrusion 112, it enables quick engagement during blind operation, improving deployment efficiency.

In other embodiments (not shown), the protrusion 112 is detachably installed on the inner wall of the groove 111. If a single protrusion 112 is damaged, it can be individually replaced through threaded connection or pin structure, avoiding scrapping the entire structure and reducing maintenance costs.

In other embodiments, as shown in FIG. 5, a plurality of evenly spaced latching blocks 113 are arranged on the inner bottom wall of the groove 111. The latching blocks 113 are geometrically complementary to the hollowed-out area 210, as illustrated in FIGS. 4 and 5. When the anti-slip washer 200 is retracted, the hollowed-out area 210 nests and locks with the latching blocks 113 on the inner wall of the front ramp portion. The geometric interference between the sidewall of the latching blocks 113 and the peripheral edge of the hollowed-out area 210 restricts free movement of the washer, preventing displacement due to bumps during vehicle transport and subsequent collision wear with the ramp's inner wall. Additionally, when the anti-slip washer 200 is fixed inside the groove 111 through the latching blocks 113 and the hollowed-out area 210, it does not contact the ground, thereby maintaining the cleanliness of the washer's friction surface and ensuring consistent anti-slip performance upon each deployment.

In other embodiments, the anti-slip washer 200 possesses a degree of elasticity. The slight bending caused by this elasticity allows workers to easily lift a corner or locally deform the washer to disengage it from the latch point using their fingers (or even nails), facilitating effortless removal for subsequent rotation tasks of the anti-slip washer 200.

In other embodiments (not shown), the latching blocks 113 and the hollowed-out area 210 adopt an asymmetric dovetail groove design, permitting disengagement only when external force is applied in a specific direction (e.g., the thrust during retraction). This prevents accidental ejection of the washer due to unexpected impacts during ramp use, enhancing safety.

In other embodiments (not shown), an electric motor or electromagnetic device is used to achieve automatic sliding deployment and locking of the anti-slip washer 200, eliminating the need for manual operation and saving time and effort for workers. Furthermore, by integrating tilt sensors, pressure sensors, or environmental humidity detection modules, the system can monitor the ramp's load status, ground friction coefficient, and environmental conditions (e.g., rain or snow) in real time, automatically triggering the deployment or retraction of the washer without human intervention.

In summary, as can be seen from the above description, the present disclosure achieves the following technical effects: after the anti-slip washer 200 is rotated and deployed, it forms a transition extension area between the front ramp portion 110 and the ground, and is directly engaged with the ground by utilizing the washer's own high-friction material (such as rubber or textured metal); when a vehicle tire comes into contact with the front ramp portion 110, the tire exerts a downward component force (impact force) along the inclined surface of the ramp, and this component force generates a horizontally backward sliding force at the bottom of the ram; at this point, since the anti-slip washer 200 is connected to the front ramp portion 110 and part of the tire is positioned on the upper surface of the anti-slip washer 200, it can apply downward pressure to the washer; the downforce from the tire creates a significant static friction force between the anti-slip washer 200 and the ground, with the friction direction being forward (opposite to the ramp's backward sliding tendency), thereby preventing the ramp from moving and avoiding displacement of the ramp body 100.

In the description of the present disclosure, it should be appreciated that directional terms such as “front, rear, up, down, left, right”, “horizontal, vertical, perpendicular, horizontal” and “top, bottom” etc. indicate the orientation or positional relationship based on the orientation or positional relationship shown in the drawings, and are only for the convenience of describing the present disclosure and simplifying the description. In the absence of a contrary explanation, these directional terms do not indicate or imply that the device or element referred to must have a specific orientation or be constructed and operated in a specific orientation, and therefore should not be understood as limiting the scope of protection of the present disclosure; the directional terms “inside, outside” refer to the inside and outside relative to the contour of each component itself.

For the convenience of description, spatial relative terms such as “on . . . ”, “above . . . ”, “on the upper surface of . . . ”, “upper” etc. may be used here to describe the spatial positional relationship of a device or feature with other devices or features as shown in the drawings. It should be appreciated that spatial relative terms are intended to encompass different orientations of the device in use or operation other than the orientation described in the drawings. For example, if the device in the drawing is inverted, the device described as “above other devices or structures” or “on other devices or structures” will subsequently be positioned as “below other devices or structures” or “under other devices or structures”. Thus, the exemplary term “above” can include both “above” and “below” orientations. The device can also be positioned in other different ways (rotated 90 degrees or in other orientations), and the spatial relative descriptions used here should be interpreted accordingly.

In addition, it should be noted that the use of terms such as “first”, “second” etc. to define components is for the convenience of distinguishing the corresponding components. Unless otherwise stated, the above terms have no special meaning, and therefore should not be understood as limiting the scope of protection of the present disclosure.

The above description is only a preferred embodiment of the present disclosure and is not intended to limit the present disclosure. For those skilled in the art, the present disclosure can have various modifications and changes. Any modifications, equivalent replacements, improvements etc. made within the spirit and principles of the present disclosure should be included within the scope of protection of the present disclosure.

What is claimed is:

1. A vehicle ramp, comprising a ramp body; and
an anti-slip assembly, comprising:
an anti-slip washer pivotally connected to a ground connecting edge at a front end of the ramp body through a pivot shaft;
wherein the anti-slip washer has:
a retracted state: the anti-slip washer is fitted to a contour of a front edge of the ramp body; and
a deployed state: the anti-slip washer is rotated to be deployed beyond the front edge of the ramp body and lay flat on the ground; and
when the anti-slip washer is in the deployed state and a vehicle tire drives onto the ramp body, part of the tire is located on an upper surface of the anti-slip washer, and a downforce of the tire generates a forward static friction force between the anti-slip washer and the ground, wherein the static friction force counteracts a rearward sliding force caused by an impact force of the tire and acting on a bottom part of the ramp body, thereby preventing the ramp body from sliding backward.

2. The vehicle ramp according to claim 1, wherein the ramp body comprises:
a front ramp portion, which forms a downward-sloping acute-angle slope surface in entirety, with a bottom surface of a tail end of the acute-angle slope surface forming a lip edge structure; and
a rear ramp portion fixedly connected to an end of the front ramp portion away from the lip edge structure.

3. The vehicle ramp according to claim 2, wherein a groove is arranged on the front edge of the ground connecting end of the front ramp portion, and one end of the groove is flush with a lip edge of the front ramp portion; and
the anti-slip washer is pivotally connected within the groove, and the anti-slip washer is entirely embedded in the groove and maintains a certain height from the ground when in the retracted state.

4. The vehicle ramp according to claim 3, wherein a plurality of arrayed hollowed-out areas are arranged on a surface of the anti-slip washer.

5. The vehicle ramp according to claim 4, wherein a plurality of latching blocks are fixedly installed on an inner wall of the groove, and the latching blocks are geometrically complementary to the hollowed-out areas; and
when the anti-slip washer is retracted into the groove, the hollowed-out areas are nested and fixed with the latching blocks, and a geometric interference between the sidewalls of the latching blocks and the edges of the hollowed-out areas restricts free movement of the washer.

6. The vehicle ramp according to claim 4, wherein a plurality of protrusions are arranged on the inner wall of the groove at the lip edge of the front ramp portion, and the protrusions are geometrically complementary to the hollowed-out area; and
when the anti-slip washer is deployed, the hollowed-out areas are nested and fixed with the protrusions, at which point the protrusions restrict free movement of the washer through contact with the sidewalls.

7. The vehicle ramp according to claim 6, wherein the protrusions are detachably installed on the inner wall of the groove.

8. The vehicle ramp according to claim 1, wherein protective flanges are symmetrically arranged on both sides of the ramp body.

9. The vehicle ramp according to claim 1, wherein anti-slip patterns are arranged on an upper surface of the ramp body.

10. The vehicle ramp according to claim 1, wherein a plurality of reinforcement ribs are embedded inside the ramp body.

11. A vehicle ramp, comprising a ramp body; and
an anti-slip assembly, comprising:
an anti-slip washer translationally and slidably connected to a ground connecting edge at a front end of the ramp body;
wherein the anti-slip washer has:
a retracted state: the anti-slip washer is fitted to a contour of a front edge of the ramp body; and
a deployed state: the anti-slip washer slides to be deployed beyond the front edge of the ramp body and lay flat on the ground; and
when the anti-slip washer is in the deployed state and a vehicle tire drives onto the ramp body, part of the tire is located on an upper surface of the anti-slip washer, and a downforce of the tire generates a forward static friction force between the anti-slip washer and the ground, wherein the static friction force counteracts a rearward sliding force caused by an impact force of the tire and acting on a bottom part of the ramp body, thereby preventing the ramp body from sliding backward.

12. The vehicle ramp according to claim 11, wherein the ramp body comprises:
a front ramp portion, which forms a downward-sloping acute-angle slope surface in entirety, with a bottom surface of a tail end of the acute-angle slope surface forming a lip edge structure; and
a rear ramp portion fixedly connected to an end of the front ramp portion away from the lip edge structure.

13. The vehicle ramp according to claim 12, wherein a groove is provided on the front edge of the ground connecting end of the front ramp portion, and one end of the groove is flush with a lip edge of the front ramp portion; and
the anti-slip washer is slidably arranged within the groove, and the anti-slip washer is entirely located within the groove and maintains a certain height from the ground when in the retracted state.

14. A vehicle ramp, comprising a ramp body; and
an anti-slip assembly, comprising:
an anti-slip washer operably connected to a ground connecting edge at a front end of the ramp body;
wherein the anti-slip washer has:
a retracted state: the anti-slip washer is fitted to a contour of a front edge of the ramp body; and
a deployed state: the anti-slip washer is movably deployed beyond the front edge of the ramp body to lay flat on the ground; and
when the anti-slip washer is in the deployed state and a vehicle tire drives onto the ramp body, part of the tire is located on an upper surface of the anti-slip washer, and a downforce of the tire generates a forward static friction force between the anti-slip washer and the ground, wherein the static friction force counteracts a rearward sliding force caused by an impact force of the tire and acting on a bottom part of the ramp body, thereby preventing the ramp body from sliding backward.

15. The vehicle ramp according to claim 14, wherein the ramp body comprises:
a front ramp portion, which forms a downward-sloping acute-angle slope surface in entirety, with a bottom surface of a tail end of the acute-angle slope surface forming a lip edge structure; and
a rear ramp portion fixedly connected to an end of the front ramp portion away from the lip edge structure.

16. The vehicle ramp according to claim 15, wherein a groove is provided on the front edge of the ground connecting end of the front ramp portion, with one end of the groove flush with a lip edge of the front ramp portion; and
the anti-slip washer is movably arranged within the groove, and the anti-slip washer is entirely embedded in the groove and maintains a certain height from the ground when in the retracted state.

17. The vehicle ramp according to claim 16, wherein a plurality of arrayed hollowed-out areas are arranged on a surface of the anti-slip washer.

18. The vehicle ramp according to claim 17, wherein a plurality of latching blocks are fixedly installed on an inner wall of the groove, and the latching blocks are geometrically complementary to the hollowed-out areas; and
when the anti-slip washer is retracted into the groove, the hollowed-out areas are nested and fixed with the latching blocks, and a geometric interference between the sidewalls of the latching blocks and the edges of the hollowed-out areas restricts free movement of the washer.

19. The vehicle ramp according to claim 17, wherein a plurality of protrusions are arranged on the inner wall of the groove at the lip edge of the front ramp portion, and the protrusions are geometrically complementary to the hollowed-out area; and
when the anti-slip washer is deployed, the hollowed-out area are nested and fixed with the protrusions, at which point the protrusions restrict free movement of the washer through contact with the sidewalls.

20. The vehicle ramp according to claim 19, wherein the protrusions are detachably installed on the inner wall of the groove.
